(19) United States
(12) Patent Application Publication
(10) Pub. No.: US 2013/0232979 A1
(43) Pub. Date: Sep. 12, 2013

(54) SYSTEM FOR ENHANCING MIXING IN A MULTI-TUBE FUEL NOZZLE

(71) Applicant: Arjun Singh, Bangalore (IN)

(72) Inventor: Arjun Singh, Bangalore (IN)

(73) Assignee: General Electric Company, Schenectady, NY (US)

(21) Appl. No.: 13/418,276

(22) Filed: Mar. 12, 2012

(51) Int. Cl. F02C 7/22; F23R 3/10

(52) U.S. Cl. 60/737

(57) ABSTRACT

A system includes a multi-tube fuel nozzle including a fuel nozzle head and multiple tubes. The fuel nozzle head includes an outer wall surrounding a chamber, and the outer wall includes a downstream wall portion that faces a combustion region. The multiple tubes extend through the chamber to the downstream wall portion, and each tube includes an air inlet into the tube, a fuel inlet including a protrusion extending radially into the tube in a crosswise direction relative to a longitudinal axis of the tube, and an outlet from the tube.

### BACKGROUND OF THE INVENTION

The subject matter disclosed herein relates to a turbine engine and, more specifically, to a system to increase fuel-air mixing in a multi-tube fuel nozzle.

A gas turbine engine combusts a mixture of fuel and air to generate hot combustion gases, which in turn drive one or more turbine stages. In particular, the hot combustion gases force turbine blades to rotate, thereby driving a shaft to rotate one or more loads, such as an electrical generator. The gas turbine engine includes a fuel nozzle to inject fuel and air into a combustor. If the mixture of fuel and air is not well-mixed, the consequences could include an unstable flame, incomplete combustion, and increased production of nitric oxides (NOₓ) and other undesirable byproducts.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a multi-tube fuel nozzle including a fuel nozzle head and multiple tubes. The fuel nozzle head includes an outer wall surrounding a chamber, and the outer wall includes a downstream wall portion configured to face a combustion region. The multiple tubes extend through the chamber to the downstream wall portion, and each tube includes an air inlet into the tube, a fuel inlet including a protrusion extending radially into the tube in a crosswise direction relative to a longitudinal axis of the tube, and an outlet from the tube.

In accordance with a second embodiment, a system includes a premixing tube configured to mount in a multi-tube fuel nozzle. The premixing tube includes an air inlet into the premixing tube a fuel inlet, and an outlet from the premixing tube. The fuel inlet has a protrusion extending radially into the premixing tube in a crosswise direction relative to a longitudinal axis of the premixing tube. The air inlet is upstream from the fuel inlet, and the outlet is downstream from both the air inlet and the fuel inlet.

In accordance with a third embodiment, a system includes a turbine fuel nozzle. The turbine fuel nozzle includes a premixing tube with an air inlet into the premixing tube, a fuel inlet having a protrusion extending radially into the premixing tube in a crosswise direction relative to a longitudinal axis of the premixing tube, and an outlet from the premixing tube. The air inlet is upstream from the fuel inlet, and the outlet is downstream from both the air inlet and the fuel inlet.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system that includes a system to increase fuel-air mixing in a multi-tube fuel nozzle;

FIG. 2 is a cross-sectional view of an embodiment of a combustor that includes a plurality of multi-tube fuel nozzles;

FIG. 3 is a front plan view of an embodiment of the combustor taken along line 3-3 of FIG. 2, illustrating a plurality of circular multi-tube fuel nozzles spaced apart from one another in cap;

FIG. 4 is a front plan view of an embodiment of the combustor taken along line 3-3 of FIG. 2, illustrating a plurality of wedge-shaped multi-tube fuel nozzles disposed directly adjacent to one another in a multi-sector arrangement;

FIG. 5 is a cross-sectional view of an embodiment of a multi-tube fuel nozzle having a plurality of premixing tubes with radially protruding fuel inlets;

FIG. 6 is a partial cross-sectional side view of an embodiment of a single premixing tube taken within line 6-6 of FIG. 5, illustrating a radially protruding fuel inlet that is perpendicular to a longitudinal axis;

FIG. 7 is a partial cross-sectional side view of an embodiment of a single premixing tube taken within line 6-6 of FIG. 5, illustrating a radially protruding fuel inlet that is crosswise to a longitudinal axis and forms an acute angle with the longitudinal axis;

FIG. 8 is a partial cross-sectional side view of an embodiment of a single premixing tube taken within line 6-6 of FIG. 5, illustrating radially protruding fuel inlets in a diametrically opposed configuration;

FIG. 9 is a partial cross-sectional side view of an embodiment of a single premixing tube taken within line 6-6 of FIG. 5, illustrating radially protruding fuel inlets in an axially staggered configuration;

FIG. 10 is a partial cross-sectional side view of an embodiment of a single premixing tube taken within line 6-6 of FIG. 5, illustrating radially protruding fuel inlets that vary in radial depth into the tube, vary in diameter, vary in tubular shape, and vary in configuration;

FIG. 11 is a partial cross-sectional side view of an embodiment of a single premixing tube taken within line 6-6 of FIG. 5, illustrating radially protruding fuel inlets that vary in angles relative to a longitudinal axis, vary in radial depth into the tube, and vary in diameter;

FIG. 12 is a cross-sectional view of an embodiment of a single premixing tube with radially protruding fuel inlets with axes that converge directly toward a longitudinal axis; and

FIG. 13 is a cross-sectional view of an embodiment of a single premixing tube with radially protruding fuel inlets oriented at an angle configured to induce a swirling flow about a longitudinal axis.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed towards systems to increase fuel-air mixing within a multi-tube fuel nozzle. The multi-tube fuel nozzle may have multiple premixing tubes that each has one or more radially protruding fuel inlets to inject fuel into a flow of air. As may be appreciated, fluid velocity is highest at the center of the premixing tube, and the fuel inlets increase jet penetration proximate to this high velocity region. As a result, the formation of combustion byproducts, such as nitric oxides, may be decreased. Further, the length of the premixing tube may be decreased, resulting in a shorter length fuel nozzle and combustor.

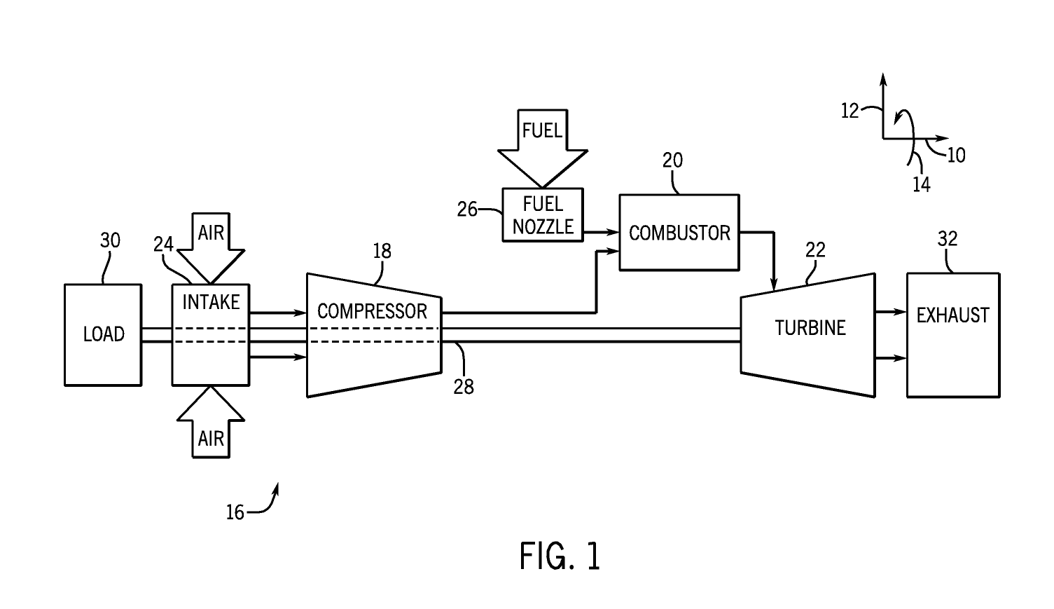

FIG. 1 is a block diagram of an embodiment of a turbine system 16 with a fuel nozzle 26 (e.g., multi-tube fuel nozzle) equipped with multiple premixing tubes 68, each having one or more radially protruding fuel inlets 11 to increase fuel-air mixing. Throughout the discussion, a set of axes will be referenced. These axes are based on a cylindrical coordinate system and point in an axial direction 10, a radial direction 12, and a circumferential direction 14. For example, the axial direction 10 extends along the length (or longitudinal axis) of the premixing tubes, the radial direction 12 extends away from the longitudinal axis, and the circumferential direction 14 extends around the longitudinal axis.

The turbine system 16 includes a compressor 18, a combustor 20, and a turbine 22. The compressor 18 receives air from an intake 24 and compresses the air for delivery to the combustor 20. The combustor 20 also receives fuel from fuel nozzles 26. The air and fuel are fed to the combustor 20 in a specified ratio suitable for optimum combustion, emissions, fuel consumption, and power output. The air and fuel mix and react to form combustion products. If the air and fuel are not well-mixed, undesirable combustion byproducts, such as nitric oxides, can form. Certain embodiments of turbine system 16 include systems for increasing fuel-air mixing to reduce the amount of combustion byproducts that are formed, particularly nitric oxides. The hot combustion products are fed into the turbine 22, which causes a shaft 28 to rotate. The shaft 28 is also coupled to the compressor 18 and a load 30. The rotating shaft 28 provides the energy for the compressor 18 to compress air, as described previously. The load 30 can be an electric generator or any device capable of utilizing the mechanical energy of the shaft 28. Finally, the combustion products exit the turbine 22 and are discharged through to an exhaust outlet 32.

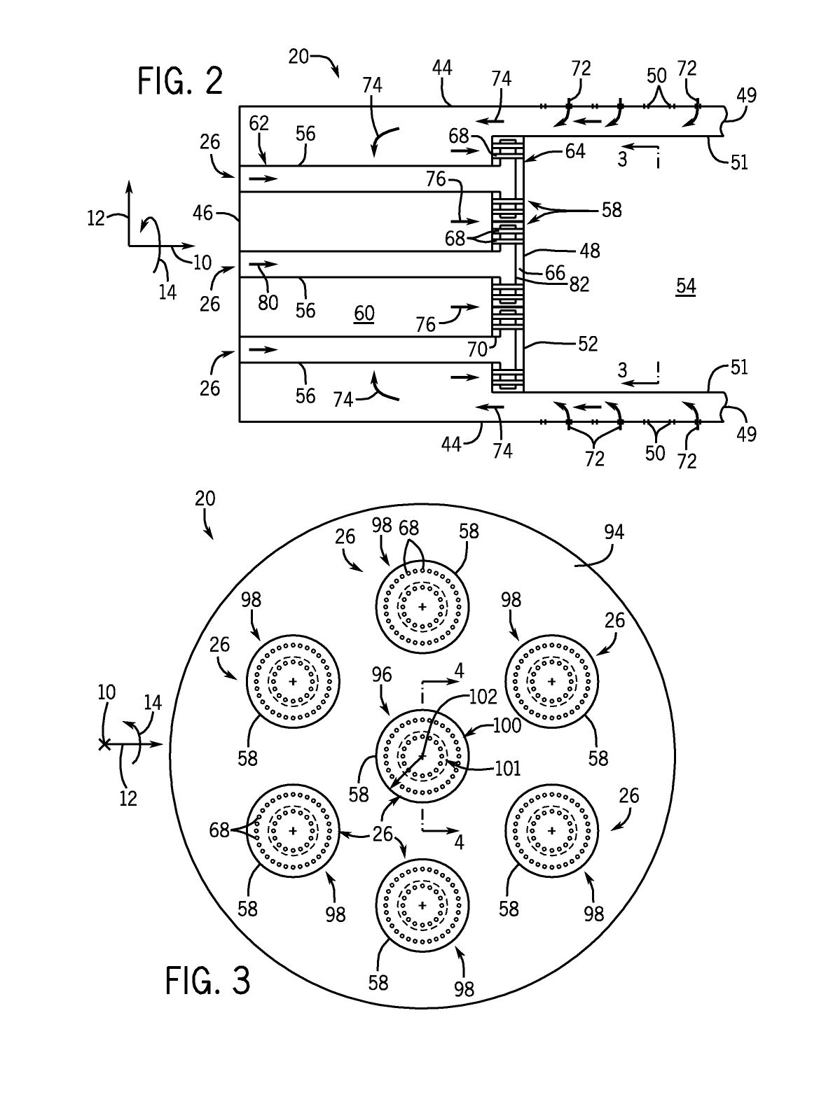

FIG. 2 is a cross-sectional side view of an embodiment of the combustor 20 including multi-tube fuel nozzles 26, each having premixing tubes 68 with one or more radially protruding fuel inlets 11 to enhance fuel-air mixing. The combustor 20 includes a flow sleeve or outer casing 44, an end cover 46, and a cap member or divider wall 94 and/or an outer wall 48 of the fuel nozzles 26. The outer casing 44 has air inlets 50, which allow air to flow into an annular space 49 between the casing 44 and a combustor liner 51. The cap member 94 and/or the outer wall 48 has a downstream wall portion 52 that faces a combustion region 54. The cap member 94 and/or the outer wall 48 separates the combustor internals from the combustion region 54. Multiple fuel nozzles 26 are mounted within the combustor 20. Each fuel nozzle 26 includes a fuel conduit 56 and a fuel nozzle head 58. Each fuel conduit 56 is oriented in the axial direction 10 through a head end 60 of the combustor 20 and from an upstream end portion 62 to a downstream end portion 64. The end cover 46 is disposed at the upstream end portion 62 and the fuel nozzle head 58 is disposed at the downstream end portion 64. The fuel nozzle head 58 includes the outer wall 48, which surrounds a fuel chamber 66 coupled to the fuel conduit 56. Premixing tubes 68 of each multi-tube fuel nozzle 26 extend through the chamber 66 from an upstream wall portion 70 to the downstream wall portion 52. Tubes 68 are arranged circumferentially 14 around the downstream portion of fuel conduit 56. In certain embodiments, each multi-tube fuel nozzle 26 may include approximately 1 to 1000, 10 to 500, or 20 to 100 premixing tubes 68, each having one or more radially 12 protruding fuel inlets to enhance fuel-air mixing.

In the arrangement shown, air flows along a path 72 through the air inlets 50 into the annular space 49 and then flows along a path 74 into the head end 60. The air then flows along a path 76 into the premixing tubes 68. Fuel enters fuel conduits 56 from the fuel supply and follows path 80 into fuel chamber 66. In the embodiment shown, fuel chamber 66 also includes a baffle 82, which forces the fuel to flow around the baffle 82 to reach the radially protruding fuel inlets of the premixing tubes 68. Fuel enters the radially protruding fuel inlets and mixes with air within the tubes 68. The fuel-air mixture flows through the premixing tubes 68 and enters combustion region 54, where the mixture is converted into hot combustion products.

FIG. 3 is a front plan view of an embodiment of the combustor 20 taken along line 3-3 of FIG. 2, illustrating a plurality of circular multi-tube fuel nozzles 26 (e.g., 96, 98) spaced apart from one another in a cap member 94. As illustrated, the combustor 20 includes a central fuel nozzle 96 centrally located within the cap member 94 of the combustor 20. The combustor 20 also includes multiple outer fuel nozzles 98 disposed circumferentially about the center fuel nozzle 96. As illustrated, six outer fuel nozzles 98 surround the center fuel nozzle 96. Each fuel nozzle 26 includes the plurality of tubes 68. As illustrated, the plurality of tubes 68 of each fuel nozzle 26 is arranged in multiple rings 100 and 101. The rings 100 and 101 have a concentric arrangement about a central axis 102 of each fuel nozzle 26. In certain embodiments, the number of rings 100 and 101, number of tubes 68 per ring 100 and 101, and arrangement of the plurality of tubes 68 may vary. Again, each tube 68 may include one or more (e.g. 1 to 50) radially protruding fuel inlets 11 to enhance fuel-air mixing in each tube 68.

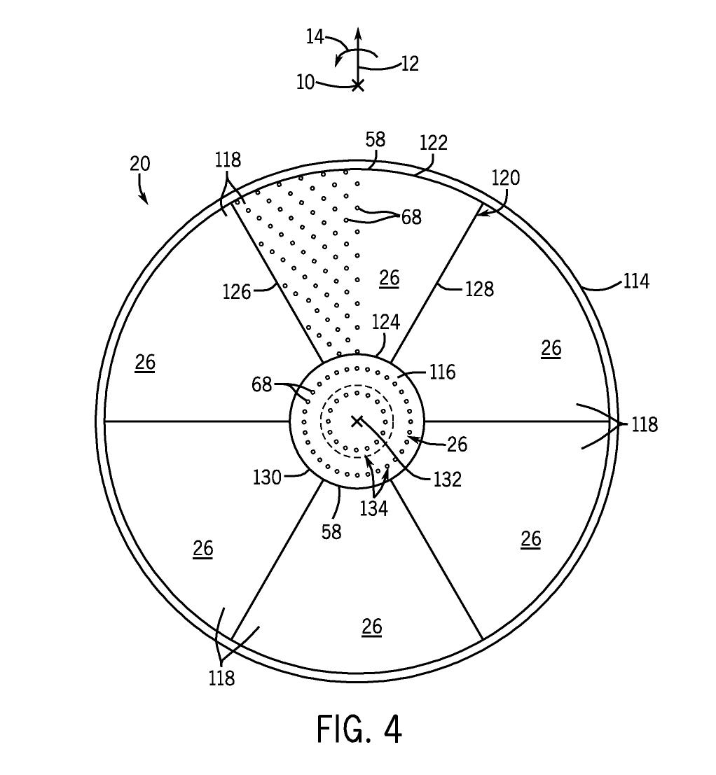

FIG. 4 is arrangement front plan view of an embodiment of the combustor 20 taken along line 3-3 of FIG. 2, illustrating a plurality of wedge-shaped multi-tube fuel nozzles 26 (e.g., 116, 118) disposed directly adjacent to one another in a multi-sector arrangement. The combustor 20 includes an outer support structure 114 extending circumferentially 14 about the fuel nozzles 26. As illustrated, the combustor 20 includes a center fuel nozzle 116 and multiple outer fuel nozzles 118 disposed circumferentially about the center fuel nozzle 116. Six outer fuel nozzles 118 surround the center fuel nozzle 116. However, in certain embodiments, the number of fuel nozzles 26 as well as the arrangement of the fuel nozzles 26 may vary. For example, the number of outer fuel nozzles 118 may be 1 to 20, 1 to 10, or any other number. For simplicity, only some of the tubes 68 are shown in the outer fuel nozzles 118 and the central fuel nozzle 116. However, each fuel nozzle 26 includes multiple premixing tubes 68.

Each outer fuel nozzle 118 includes a non-circular perimeter 120. As illustrated, the perimeter 120 includes a wedge shape or truncated pie shape with opposing sides 122 and 124 and opposing sides 126 and 128. The sides 122 and 124 are arcuate shaped sides that are radially 12 offset from one another. The sides 126 and 128 are linear and generally converge toward one another from side 122 to side 124. However, in certain embodiments, the perimeter 120 of the outer fuel nozzles 118 may include other shapes, e.g., a pie shape with three sides. Regardless of the shape, each outer fuel nozzle 118 is a multi-tube fuel nozzle 26 with a plurality of premixing tubes 68, each having one or more (e.g., 1 to 50) radially protruding fuel inlets 11 to enhance fuel-air mixing in the tubes 68. Similarly, the center fuel nozzle 116 is a multi-tube fuel nozzle 26 with a plurality of the premixing tubes 68, each having one or more (e.g., 1 to 50) radially protruding fuel inlets 11 to enhance fuel-air mixing in the tubes 68. The center fuel nozzle 116 includes a perimeter 130 (e.g., circular perimeter). In certain embodiments, the perimeter 130 may include other shapes, e.g., a square, hexagon, triangle, or other polygon. The perimeter 130 of the center fuel nozzle 116 may be coaxial with a central axis 132 of the combustor 20 a may include concentric rings 134 of the premixing tubes 68.

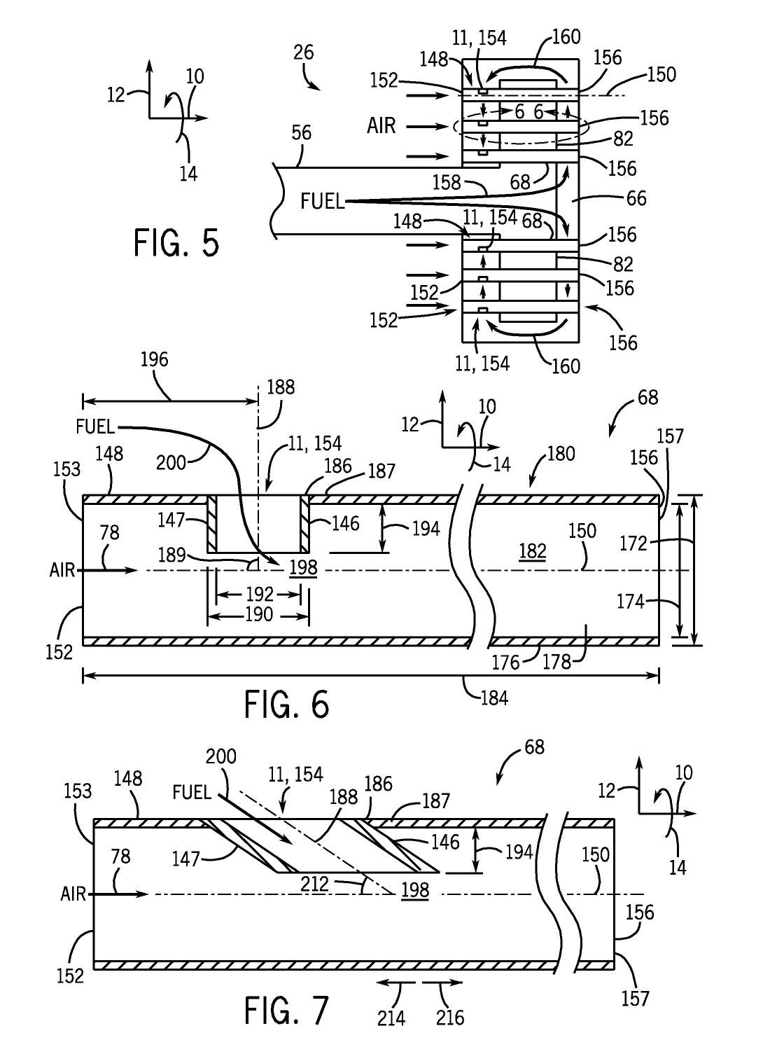

FIG. 5 is a cross-sectional view of an embodiment of the multi-tube fuel nozzle 26 (e.g., fuel nozzles 96, 98, 116, and 118) with premixing tubes 68, each having one or more radially protruding fuel inlets 11, 154 with respective protrusions 146 to increase fuel-air mixing. Each tube 68 is cylindrical about a centerline 150 in the axial direction 10. Each tube 68 has an air inlet 152 into the tube, a radially 12 protruding fuel inlet 11, 154 into the tube, and an outlet 156 out of the tube. As shown, air inlet 152 extends axially 10 in the direction of centerline 150 at upstream end portion 148 of the tube 68. Fuel inlet 154 comprises a protrusion 146 (e.g., a hollow protrusion) extending into the tube 68 in a crosswise direction (e.g., a radial direction 12) relative to a longitudinal axis (e.g., centerline 150) of the tube 68. Both air inlet 152 and the outlet 156 are external to the chamber 66.

Air from the head end 60 flows into each premixing tube 68 via air inlet 152. Fuel from the fuel supply travels though fuel conduit 56 and into chamber 66 through a flow path 158. The fuel encounters the baffle 82, which forces the fuel to follow a path 160 through the chamber 66 to help uniformly distribute the fuel to the fuel inlets 154 of the plurality of premixing tubes 68. The fuel then enters premixing tubes 68 through fuel inlets 154. Within each premixing tube 68, the air and fuel contact each other, mix, and exit the tube 68 through the outlet 156 into the combustion region 54 with a well-mixed composition. The protrusion 146 helps the fuel penetrate further into each tube 68 (e.g., in radial direction 12), thereby enhancing fuel-air mixing in the tube 68. The protrusion 146 also may enhance mixing by disturbing the flow, inducing turbulence, inducing swirling flow, inducing vortices, or any combination thereof. As discussed in detail below, each tube 68 may include 1 to 100 (e.g., 1, 2, 3, 4, 5, or more) fuel inlets 154 with protrusions 146, and each protrusion 146 may have a common or different diameter, radial 12 height, shape, angle relative to the axis 150, or any combination thereof.

FIG. 6 is a partial cross-sectional side view of an embodiment of the single premixing tube 68 taken within line 6-6 of FIG. 5, illustrating a radially 12 protruding fuel inlet 11, 154 that is perpendicular to the longitudinal axis 150. The premixing tube 68 is symmetric about the centerline 150 in the axial direction 10 and has an outer diameter 172, an inner diameter 174 (e.g., internal diameter), an outer surface 176, an inner surface 178, and a tubular shape 180. The cross-sectional area available for fluid flow, or flowing area 182, is a function of the inner diameter 174. Tube 68 has the air inlet 152, the fuel inlet 154, and the outlet 156. Additionally, the fuel inlet 154 is offset from the air inlet 152 (e.g., end 153) and the outlet 156 (e.g., end 157), such that air inlet end 153 is upstream of the fuel inlet 154, and the outlet end 157 is downstream from both the air inlet 152 and the fuel inlet 154. The premixing tube 68 has a length 184 between the inlet end 153 and the outlet end 157. In certain embodiments of the turbine system 16, it may be desirable to shorten the length 184 of premixing tube 68 to decrease the size of the fuel nozzle 26 and/or the combustor 20.

The protrusion 146 is disposed at the fuel inlet 154 to inject fuel nearer the centerline 150 of premixing tube 68. Protrusion 146 may include an insert 147 that is coupled to an opening 186 in the tube 68. For example, insert 147 may be coupled to the opening 186 at a joint 187, such as a weld, braze, or other fixed or removable joint. Alternatively, protrusion 146 may be integrally formed with tube 68 as a one-piece structure. In the case of a one-piece structure, tube 68 could be formed by casting. Thus, the protrusion 146 (e.g., hollow protrusion) may be formed via casting, deformation, punching, or another technique.

The protrusion 146 of the radially protruding fuel inlet 154 is configured to increase fuel-air mixing in the premixing tube 68. The degree of mixing of the fuel-air mixture when it exits the premixing tube 68 through the outlet end 156 is also affected by the fluid velocity. The velocity of the fluid flowing through the premix tube 68 depends on the flow rate and the offset from the tube centerline 150 in radial direction 12. A fluid, such as air, may have a maximum velocity at the tube centerline 150, while having a minimum velocity along the tube wall (e.g. tube inner surface 178). Flow of the air in contact with the wall 178 is essentially zero and increases as the radial 12 offset from tube centerline 150 approaches zero. The protrusion 146 delivers fuel into a region of higher air velocity, which results in improved mixing. Furthermore, the protrusion 146 may induce turbulence, swirl, and/or formation of large scale vortices and small scale eddies to enhance fuel-air mixing within the tube 68. In other words, the protrusion 146 may generally disturb the flow, while also increasing radial 12 penetration of the fuel into the air flow. In this manner, the protrusion 146 of the radially protruding fuel inlet 154 may provide a more uniform distribution of fuel in the air, thereby improving the fuel-air distribution (i.e., more uniform) exiting each tube 68.

The tubular shape of the protrusion 146 could be cylindrical, conical, polyhedral, or another geometry suitable for delivering fuel to the premixing tube 68. The protrusion 146 has a centerline 188 in the radial direction 12, an outer diameter 190, an inner diameter 192, and a radial depth 194. Depending on the dimensions of the tube 68, the inner diameter 192 of the protrusion 146 may be approximately 25 to 500, 50 to 250, 75 to 125, or less than approximately 100 mils The protrusion 146 injects fuel at radial depth 194, which is measured from the tube inner surface 178. The radial depth 194 may range from 1 percent to 50 percent, or 5 percent to 40 percent, or 10 percent to 30 percent of the tube inner diameter 174. For example, the radial depth 194 may be greater than approximately 5, 10, 15, 20, 25, 30, 35, or 40 percent of the inner diameter 174. Generally, for a single protrusion 146, the degree of fuel penetration increases as the depth 194 approaches the tube centerline 150. The radial depth 194 also may gradually increase flow disturbance (e.g., turbulence) and mixing as it increases.

As shown, the protrusion 146 is oriented crosswise (e.g., perpendicular) to the tube centerline 150. The protrusion centerline 188 is offset from the air inlet end 153 by a distance 196. Certain embodiments may position the protrusion 146 to be proximate to the air inlet end 153 to maximize the residence time for fuel-air mixing within tube 68. In another embodiment, the fuel inlet 154 may be disposed directly at or adjacent the air inlet end 153, while still having a crosswise orientation to the tube centerline 150. For example, the distance 196 could be approximately 0 to 75, 1 to 50, 5 to 25, or 10 to 15 percent of the length 184. In certain embodiments, the axis 188 of the protrusion 146 may be oriented at an angle 189 relative to the centerline 150, wherein the angle 189 may be approximately 5 to 90, 10 to 80, 20 to 70, 30 to 60, 40 to 50, 30, 45, 60, or 90 degrees relative to the centerline 150. The angle 189 may be oriented in the upstream axial 10 direction, downstream axial 10 direction, clockwise circumferential 14 direction, or counterclockwise circumferential 14 direction.

Air enters the air inlet 152 and flows in the axial direction 10 along the premixing tube 68 toward outlet 156. At position 196, fuel enters the fuel inlet 154 and begins to mix with air at a contact area 198 (e.g., central region), as indicated by fuel path 200. The fuel-air continues to mix as the mixture flows in a primarily axial direction 10 along the tube 68. An improved fuel-air distribution is achieved when the mixture exits tube 68 through outlet end 156. Generally, the degree of mixedness of the fuel-air mixture increases along the pipe length 184, from a minimum mixedness at contact area 198 to a maximum mixedness at outlet end 156. By increasing the degree of flow disturbance and fuel penetration (e.g., radial depth 194), the protrusion 146 enables a shorter premixing tube 68 to achieve the same degree of mixedness as a longer premixing tube 68 without the protrusion 146. Similarly, the degree of mixedness of the fuel-air mixture is increased for a tube 68 with the protrusion 146 compared to that of a tube 68 of identical length 184 without the protrusion 146.

FIG. 7 is a partial cross-sectional side view of an embodiment of the single premixing tube 68 taken within line 6-6 of FIG. 5, illustrating a radially protruding fuel inlet 11, 154 that is crosswise to the centerline 150 and forms an acute angle 212 with the centerline 150. The premixing tube 68 and the protrusion 146 are structurally similar to the tube and the protrusion described in FIG. 6. The protrusion centerline 188 forms the acute angle 212 with the longitudinal axis in the axial direction 10 (e.g. tube centerline 150). The protrusion 146 may be axially 10 angled, such that the acute angle 212 is oriented in an upstream flow direction 214 or a downstream flow direction 216 (as shown) relative to the tube centerline 150. The protrusion 146 may also be circumferentially 14 angled at the acute angle 212 configured to induce a swirling flow about the tube centerline 150. In such a case, the protrusion centerline 188 is skew with tube centerline 150, and the angle 212 is defined by protrusion centerline 188 and a longitudinal axis parallel to (but radially 12 offset from) tube centerline 150. Certain embodiments may select the acute angle 212 to maximize the degree of mixedness at the outlet end 157. Additionally, other embodiments may include more than one angled protrusion 146 (e.g., 2 to 100 angled protrusion 146), which may include uniformly or differently angled protrusions 146 (e.g., 30, 45, 60, 75 and/or 90 degree angled protrusion 146).

Air enters the air inlet 152 and flows in the axial direction 10 along the premixing tube 68 toward outlet 156. At position 196, fuel enters the fuel inlet 154 and begins to mix with air at a contact area 198 (e.g., central region), as indicated by fuel path 200. The fuel-air continues to mix as the mixture flows in a primarily axial direction 10 along the tube 68. An improved fuel-air distribution is achieved when the mixture exits tube 68 through outlet end 156. Specifically, the acute angle 212 may further increase the turbulence, swirl, and/or formation of large scale vortices and small scale eddies to enhance fuel-air mixing within the tube 68. For example, if the acute angle 212 is oriented in the upstream flow direction 214, the residence time for fuel-air mixing within the tube 68 may be increased. Additionally, if the acute angle 212 is oriented in the downstream flow direction 216, the velocity of the fuel-air mixture through the tube 68 may be increased, which may increase the turbulence of the fuel-air mixture.

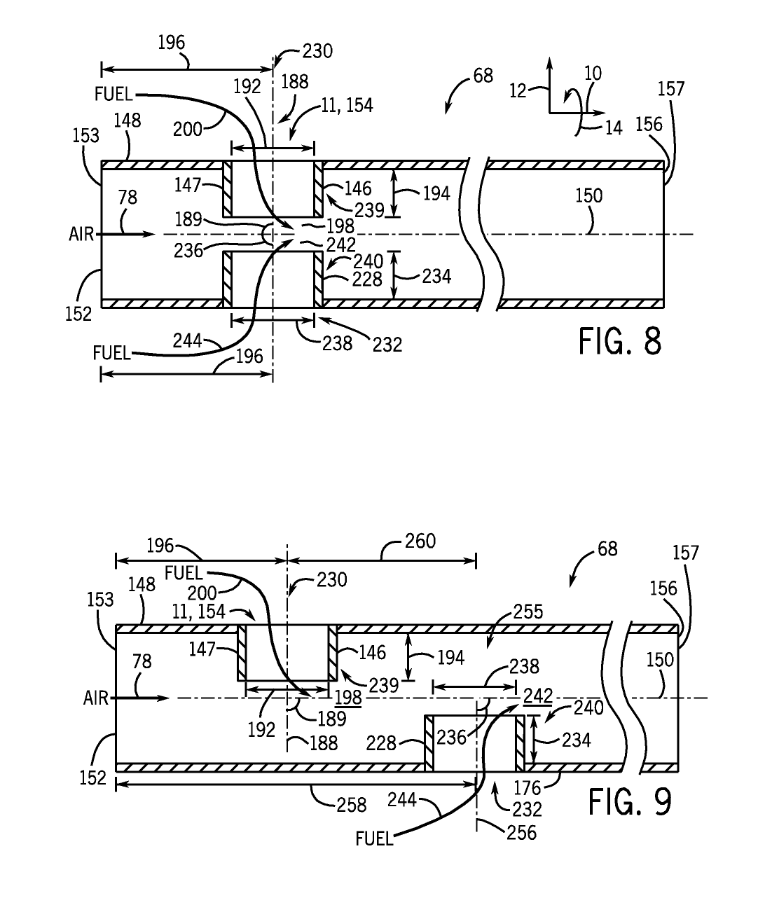

FIG. 8 is a partial cross-sectional side view of an embodiment of the single premixing tube 68 taken within line 6-6 of FIG. 5, illustrating radially protruding fuel inlets 11, 154 in a diametrically opposed configuration. The protrusions 146 and 228 are in a diametrically opposed configuration at a common axial position 230 relative to tube centerline 150. The protrusion 228 extends in the radial direction 12 into the tube 68 in a crosswise direction (e.g., radial 12 direction) relative to the tube centerline 150. The premixing tube 68 is structurally similar to the premixing tube described in FIG. 6 with the exception that the tube 68 has two radially 12 opposed fuel inlets 154 and 232. According to other embodiments, the number of fuel inlets and protrusions may vary between approximately 2 to 100, 3 to 50, 4 to 25, or 5 to 10. The protrusions 146 and 228 direct fuel towards the tube centerline 150. The protrusion 228 may be the same or different than protrusion 146. For example, protrusions 146 and 228 may vary in radial depth 194, 234 into the tube 68; angle 189, 236 relative to the centerline 150; diameter 192, 238; tubular shape 239, 240; or any combination thereof. As illustrated, the protrusions 146 and 228 share the common axial position 230, while being circumferentially 14 offset from one another (e.g., rotated 180 degrees in the circumferential direction 14 about the centerline 150). In other embodiments, the protrusions 146 and 228 may share the common axial position 230, but may be circumferentially 14 offset from one another at a different angle, such as approximately 10 to 180, 30 to 150, or 45 to 135 degrees. As illustrated, the axial position 230 of the protrusions 146 and 228 are both offset from the air inlet end 153 by the axial distance 196. In certain embodiments, the distance 196 could be chosen such that protrusions 146 and 228 are proximate to the air inlet end 1523 to maximize the residence time for fuel-air mixing within the tube 68. In particular, the fuel inlets 154, 232 may be disposed along an upstream portion of the tube 68 and may be within the distance 196 that is approximately 0 to 75, 1 to 50, or 5 to 25 percent of the length 184. Further, the protrusions 146 and 228 may be angled the same or different as discussed in FIG. 7.

Air enters the air inlet 152 and flows in the axial direction 10 along the premixing tube 68 toward outlet 156. At position 196, fuel enters the fuel inlets 154, 232 and begins to mix with air at contact areas 198, 242 (e.g., central regions), as indicated by fuel paths 200, 244. In certain embodiments, the fuel inlets 154, 232 may share the contact area 198 (e.g., fuel jets directly impinge one another in area 198). The fuel-air mixture continues to mix as the mixture flows in a primarily axial direction 10 along the tube 68. An improved fuel-air distribution is achieved when the mixture exits tube 68 through outlet end 156. Specifically, the opposed fuel inlets 154, 232 may further increase the turbulence, swirl, and/or formation of large scale vortices and small scale eddies to enhance fuel-air mixing within the tube 68. For example, the opposed fuel inlets 154, 232 may cause the fuel from each inlet 154, 232 to impinge onto one another other and increase the turbulence at the contact areas 198, 242. Thus, the opposed fuel inlets 154, 232 may enhance fuel-air mixing within the tube 68 and enable the tube 68 to be shortened.

FIG. 9 is a partial cross-sectional side view of an embodiment of the single premixing tube 68 taken within line 6-6 of FIG. 5, illustrating radially protruding fuel inlets 11 (e.g., 154, 232) in an axially 10 staggered configuration 255 at different axial positions 230 and 256. Premixing tube 68 is structurally similar to premixing tube described in FIG. 8 with the exception that the fuel inlets 154 and 232 are in the staggered configuration 255. The protrusion 228 may be the same or different than protrusion 146. For example, protrusions 146 and 228 may vary in radial depth 194, 234 into the tube 68; angle 189, 236 relative to the centerline 150; diameter 192, 238; tubular shape 239, 240; or any combination thereof. As illustrated, the axial position 230 of the protrusion 146 is axially 10 offset from the air inlet end 153 by the distance 196. Additionally, the axial position 256 of the protrusion 228 is axially 10 offset from the air inlet end 153 by a distance 258. The distances 196 and 258 may be equal or different. However, as illustrated, the distances 196 and 258 are different to define an axial spacing or offset 260 between the fuel inlets 154 and 232 and the associated protrusions 146 and 228. In certain embodiments, the spacing 260 may be approximately 0 to 75, 1 to 50, 5 to 25, or 10 to 15 percent of the length 184 of the tube 68. In yet other embodiments, the spacing 260 may be approximately 1 to 1000, 10 to 150, or 20 to 90 percent of the inner diameter 174 of the tube 68. As may be appreciated, the tube 68 may have any number (e.g., approximately 2 to 100, 5 to 50, 10 to 25) of fuel inlets (154 and 232) and associated protrusions (e.g., 146 and 228) at various axial 10 positions, radial 12 depths, angles, circumferential 14 positions, or any combination thereof.

Air enters the air inlet 152 and flows in the axial direction 10 along the premixing tube 68 toward outlet 156. At positions 196 and 258, fuel enters the fuel inlets 154, 232 and begins to mix with air at contact areas 198, 242 (e.g., central regions), as indicated by fuel paths 200, 244. The fuel-air mixture continues to mix as the mixture flows in a primarily axial direction 10 along the tube 68. An improved fuel-air distribution is achieved when the mixture exits tube 68 through outlet end 156. Specifically, the staggered fuel inlets 154, 232 may further increase the turbulence, swirl, and/or formation of large scale vortices and small scale eddies to enhance fuel-air mixing within the tube 68. For example, the staggered fuel inlets 154, 232 may cause the fuel from each inlet 154, 232 to impinge onto opposite sides of the tube inner surface 178 and increase the turbulence at the contact areas 198, 242. Thus, the opposed fuel inlets 154, 232 may enhance fuel-air mixing within the tube 68 and enable the tube 68 to be shortened.

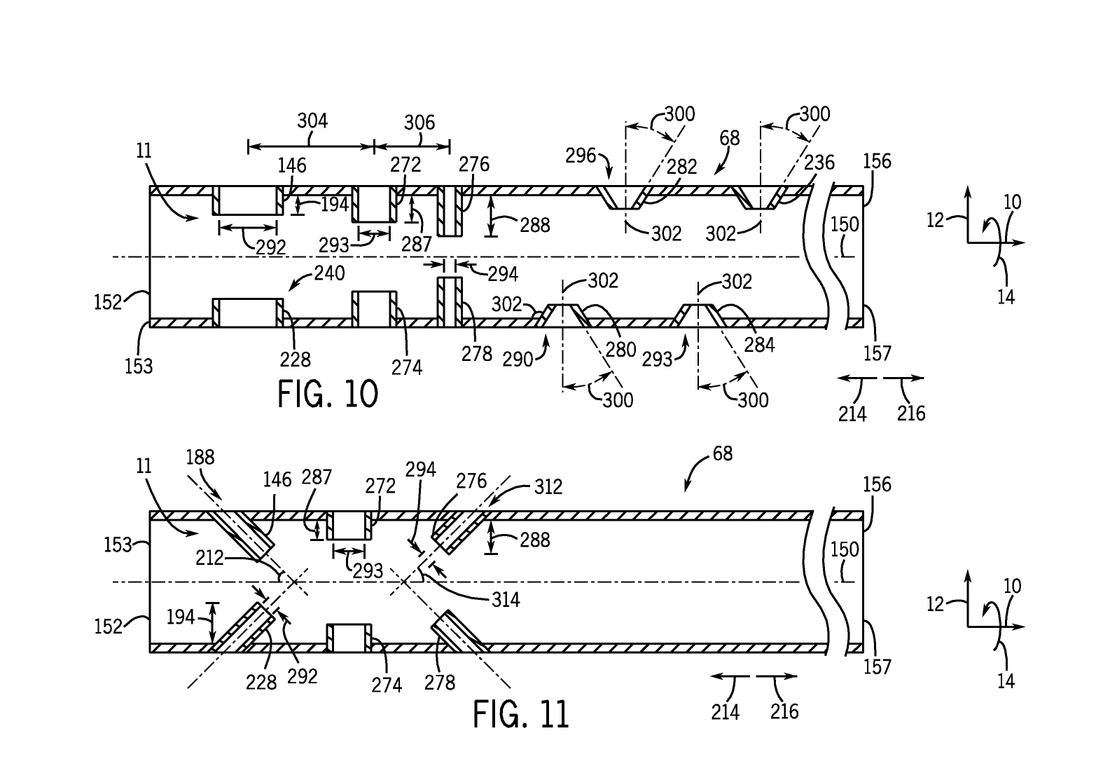

FIG. 10 is a partial cross-sectional side view of an embodiment of the single premixing tube 68 taken within line 6-6 of FIG. 5, illustrating radially protruding fuel inlets 11 that vary in radial 12 depth into the tube, vary in diameter, vary in tubular shape, and vary in configuration. In particular, the premixing tube 68 has protrusions 146, 228, 272, 274, 276, 278, 280, 282, 284, and 286 associated with the fuel inlets 11 that vary in radial 12 depth into the tube, vary in diameter, vary in tubular shape, and vary in configuration. FIG. 10 depicts many variations and combinations of the protrusion characteristics above. It should be understood that FIG. 10 is intended to show that any of the features disclosed herein are capable of use together, and thus are not mutually exclusive.

The protrusions 146, 228 of the fuel inlets 11 have the radial depth 194; the protrusions 272, 274 of the fuel inlets 11 have a radial depth 287; and protrusions 276, 278 of the fuel inlets 11 have a radial depth 288. The radial depths 194, 287, 288 are different from one another and progressively increase in the downstream flow direction 216. In other embodiments, the radial depths 194, 287, 288 may progressively decrease or both increase and decrease in the downstream flow direction 216. As illustrated, the protrusions 146, 228, 272, 274, 276, and 278 of the fuel inlets 11 have the tubular shape 240 (e.g., cylindrical), while the protrusions 280, 282, 284, and 286 have a different tubular shape 290 (e.g., conical). As shown, the conical protrusions 280, 282, 284, and 286 each converge at an angle 300 relative to a central axis 302 of the respective protrusion. In general, the angle 300 may be approximately 1 to 40, 2 to 30, 3 to 20, or 4 to 10 degrees. Furthermore, the protrusions 280, 282, 284, and 286 may have equal or different angles 300.

In addition, the protrusions 146, 228 have a diameter 292; the protrusions 272, 274 have a diameter 293, and the protrusions 276, 278 have a diameter 294. The diameters, 292, 293, 294 are different from one another and progressively decrease in the downstream flow direction 216. In other embodiments, the diameters 292, 293, 294 may progressively increase or may both increase and decrease in the downstream flow direction 216. As illustrated, the protrusion 146 is in an opposed configuration relative to the protrusion 228, the protrusion 272 is in an opposed configuration relative to the protrusion 274, and the protrusion 276 is in an opposed configuration relative to the protrusion 278. Further, each set of opposed protrusions has common features (e.g., diameter, radial depth), but has different features compared to other sets.

Further, the protrusions 282 and 284 are arranged in a staggered configuration at different axial positions 296 and 298. Similarly, the protrusions 280 and 286 are in a staggered configuration. Still further, the protrusions 146, 228 are staggered relative to protrusions 272, 274, 276, 278, 280, 282, 284, and 286. As may be appreciated, the protrusions may be staggered on the same or opposite sides of the tube 68. As shown in FIG. 10, any of the protrusions 146, 228, 272, 274, 276, 278, 280, 282, 284, 286 may be integrally formed with the tube 68 or may be an insert 147 coupled to the tube 68 via the joint 187 as discussed previously.

Still further, the tube 68 has a spacing 304 between the protrusions 146, 228 and the protrusions 272, 274 and a spacing 306 between the protrusions 272, 274 and the protrusions 276, 278. As shown, the spacings 304, 306 gradually decrease along the length 184 of the tube 68 in the downstream flow direction 216. In other embodiments, the spacings 304, 306 may gradually increase or may be random along the length 184 of the tube 68.

FIG. 11 is a partial cross-sectional side view of an embodiment of the single premixing tube 68 taken within line 6-6 of FIG. 5, illustrating radially protruding fuel inlets 11 that vary in angles relative to the centerline 150, vary in radial 12 depth into the tube, and vary in diameter. It should be understood that FIG. 11 is intended to show that any of the features disclosed herein are capable of use together, and thus are not mutually exclusive.

As illustrated, the protrusions 146, 228 (e.g., centerline 188) are both oriented at an acute angle 212 with the tube centerline 150 in the downstream flow direction 216. In addition, protrusions 276, 278 (e.g., centerline 312) are both oriented at an acute angle 314 with tube centerline 150 in the upstream flow direction 214. In general, the acute angles 212, 314 may be the same or different from one another, e.g., approximately 1 to 89, 5 to 85, 20 to 70, or 35 to 55 degrees. As shown, the protrusions 146, 228 have the radial depth 194; the protrusions 272, 274 have a radial depth 287; and protrusions 276, 278 have the radial depth 288. The radial depths 194, 287, 288 are different from one another and progressively decrease in the downstream flow direction 216. In other embodiments, the radial depths 194, 287, 288 may progressively increase or both increase and decrease in the downstream flow direction 216. In addition, the protrusions 146, 228 have the diameter 292; the protrusions 272, 274 have the diameter 293, and the protrusions 276, 278 have the diameter 294. The diameters, 292, 293, 294 are different from one another and both increase and decrease along the length 184 of the tube 68. In other embodiments, the diameters 292, 293, 294 may progressively decrease or progressively increase in the downstream flow direction 216.

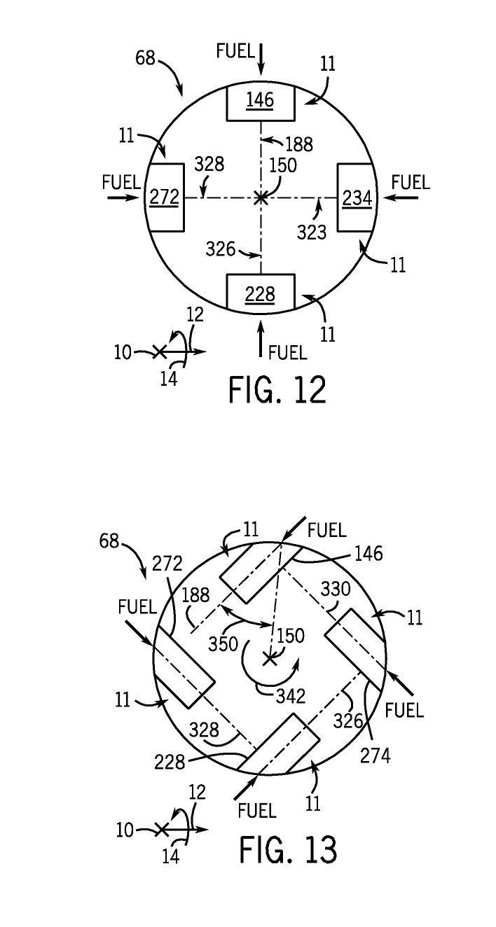

FIG. 12 is a cross-sectional view of an embodiment of the single premixing tube 68 with radially 12 protruding fuel inlets 11 with axes that converge directly toward a longitudinal axis (e.g., centerline 150). The tube 68 includes the protrusions 146, 228, 272, and 274 that do not induce a swirling flow about the tube centerline 150, as each protrusion centerline 188, 326, 328, 330 intersects tube centerline 150. In other embodiments, the protrusions 146, 228, 272, 274 may be uniformly or differently spaced circumferentially 14 about the centerline 150.

FIG. 13 is a cross-sectional view of an embodiment of the single premixing tube 68 with radially protruding fuel inlets 11 (e.g., protrusions 146 228, 272, and 274) oriented at an angle configured to induce a swirling flow about the tube centerline 150. In particular, each fuel inlet 11 (e.g., protrusions 146, 228, 272, 274) is oriented at an angle 350 relative to a radius or radial line 352. For example, the angle 350 may be defined at the intersection between the tube 68, the radial line 352, and the axis 188, 326, 328, and 330 of each respective protrusion 146. The angle 350 may be the same or different from one protrusion to another. Furthermore, the angle 350 may be approximately 1 to 90, 5 to 60, 10 to 45, or 20 to 30 degrees. The arrangement shown induces a swirling flow in a counterclockwise direction 342. A different arrangement could produce a swirling flow in a clockwise direction. Further, in certain embodiments, the protrusions 146, 228, 272, 274 may be uniformly or differently spaced circumferentially 14 about the centerline 150.

Technical effects of the disclosed embodiments include a system to increase fuel-air mixing in a combustor with multi-tube fuel nozzles. A protrusion disposed at the fuel inlet on a premixing tube increases the jet penetration of the fuel. Fluid velocity is highest at the center of the tube, and the protrusion allows fuel to be injected proximate to this high velocity region. The formation of combustion byproducts, such as nitric oxides, correlate directly to the poor mixing of air and fuel. Thus, a protrusion disposed at a fuel inlet on a premixing tube decreases nitric oxide emissions for the premixing tube. The protrusion also creates a flow disturbance, which further enhances fuel-air mixing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a multi-tube fuel nozzle, comprising:
a fuel nozzle head comprising an outer wall surrounding a chamber, wherein the outer wall comprises a downstream wall portion configured to face a combustion region; and
a plurality of tubes extending through the chamber to the downstream wall portion, wherein each tube of the plurality of tubes comprises an air inlet into the tube, a first fuel inlet comprising a first protrusion extending radially into the tube in a first crosswise direction relative to a longitudinal axis of the tube, and an outlet from the tube.

2. The system of claim 1, wherein each tube has the air inlet disposed upstream from the first fuel inlet, and each tube has the outlet disposed downstream from the air inlet and the first fuel inlet.

3. The system of claim 2, wherein each tube has the air inlet extending axially into an upstream end portion of the tube.

4. The system of claim 2, wherein each tube extends through the chamber from an upstream wall portion to the downstream wall portion, and each tube has the air inlet and the outlet external to the chamber.

5. The system of claim 1, wherein each tube comprises a second fuel inlet comprising a second protrusion extending radially into the tube in a second crosswise direction relative to the longitudinal axis of the tube.

6. The system of claim 5, wherein each tube has the first and second protrusions arranged in an opposed configuration at a common axial position relative to the longitudinal axis.

7. The system of claim 5, wherein each tube has the first and second protrusions arranged in a staggered configuration at different axial positions relative to the longitudinal axis.

8. The system of claim 5, wherein each tube has the first and second protrusions with different radial depths into the tube, different angles relative to the longitudinal axis, different diameters, different tubular shapes, or any combination thereof.

9. The system of claim 1, wherein each tube has the first protrusion oriented perpendicular to the longitudinal axis.

10. The system of claim 1, wherein each tube has the first protrusion oriented at an acute angle in an upstream flow direction or a downstream flow direction relative to the longitudinal axis.

11. The system of claim 1, wherein each tube has the first protrusion oriented at an acute angle configured to induce a swirling flow about the longitudinal axis.

12. The system of claim 1, wherein each tube has the first protrusion integrally formed with the tube as a one-piece structure.

13. The system of claim 1, wherein each tube has a first insert coupled to a first opening in the tube to define the first protrusion in the tube.

14. The system of claim 1, comprising a turbine combustor having the multi-tube fuel nozzle, a gas turbine engine having the turbine combustor, or a combination thereof.

15. A system, comprising:
a premixing tube configured to mount in a multi-tube fuel nozzle, wherein the premixing tube comprises:
an air inlet into the premixing tube;
a first fuel inlet comprising a first protrusion extending radially into the premixing tube in a first crosswise direction relative to a longitudinal axis of the premixing tube; and
an outlet from the premixing tube, wherein the air inlet is disposed upstream from the first fuel inlet, and the outlet is disposed downstream from the air inlet and the first fuel inlet.

16. The system of claim 15, comprising the multi-tube fuel nozzle having a plurality of premixing tubes, a turbine combustor having the multi-tube fuel nozzle, a gas turbine engine having the turbine combustor, or a combination thereof.

17. The system of claim 15, wherein the premixing tube comprises a second fuel inlet having a second protrusion extending radially into the premixing tube in a second crosswise direction relative to the longitudinal axis, wherein the first and second protrusions have different radial depths into the premixing tube, different angles relative to the longitudinal axis, different diameters, different tubular shapes, or any combination thereof.

18. A system, comprising:
a turbine fuel nozzle, comprising:
a first premixing tube having a first air inlet into the first premixing tube, a first fuel inlet having a first protrusion extending radially into the first premixing tube in a first crosswise direction relative to a first longitudinal axis of the first premixing tube, and a first outlet from the first premixing tube, wherein the first air inlet is disposed upstream from the first fuel inlet, and the first outlet is disposed downstream from the first air inlet and the first fuel inlet.

19. The system of claim 18, wherein the turbine fuel nozzle comprises a multi-tube fuel nozzle having the first premixing tube and a second premixing tube extending through a fuel chamber, wherein the second premixing tube comprises a second air inlet into the second premixing tube, a second fuel inlet having a second protrusion extending radially into the second premixing tube in a second crosswise direction relative to a second longitudinal axis of the second premixing tube, and a second outlet from the second premixing tube, wherein the second air inlet is disposed upstream from the second fuel inlet, and the second outlet is disposed downstream from the second air inlet and the second fuel inlet.

20. The system of claim 18, wherein the first premixing tube has a first insert coupled to a first opening in the first premixing tube to define the first protrusion in the first premixing tube, and the first insert has an internal diameter less than approximately 100 mils.
